(19) United States
(12) Patent Application Publication
(10) Pub. No.: US 2010/0143780 A1
(43) Pub. Date: Jun. 10, 2010

(54) BATTERY COVER LATCH ASSEMBLY

(75) Inventors: MU-WEN YANG, Shindian (TW); CHIH-CHIANG CHANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/550,938

(22) Filed: Aug. 31, 2009

(30) Foreign Application Priority Data
Dec. 5, 2008 (CN) 200810306004.7

(51) Int. Cl. H01M 2/10

(52) U.S. Cl. 429/100

(57) ABSTRACT

A battery cover latch assembly comprises a battery housing member, a battery cover, a plurality of first latching elements and a plurality of second latching elements. The first latching elements are mounted to the battery cover. Each first latching elements includes a first latching portion. The second latching elements are mounted to the battery housing member corresponding to the first latching elements. Each second latching element has a hollow second latching portion defining a receiving space therein. The first latching portions are respectively secured in the receiving spaces of the second latching elements to secure the battery cover to the battery housing member.

### BACKGROUND

1. Technical Field

The exemplary disclosure generally relates to battery cover latch assemblies, particularly to a battery cover latch assemblies used in portable electronic devices.

2. Description of Related Art

As a power source, batteries are widely used in portable electronic devices, such as personal digital assistants (PDAs), cellular phones and etc. Conventional batteries are received in the electronic devices, and battery covers are designed to engage with housings of the electronic devices to package the batteries. The batteries have to be replaced by opening the battery covers when the batteries are damaged or cannot be recharged any more

A clasp structure or latch structure is used with a conventional battery cover to engage with a housing of a portable electronic device. For example, a latch comprises a pair of hooks at one end of the battery cover and a locking pin protruding from the other end of the battery cover. Accordingly, a pair of troughs is defined in an end portion of a backside of a housing of the cellular phone, and a locking hole is defined in the other end portion of the backside of the housing. In assembly, the hooks are firstly inserted into the troughs in the backside of the housing. Then, the battery cover is pressed downwardly towards the housing until the locking pin on the battery cover is inserted into the locking hole in the backside of the housing. The battery cover is thus assembled to the housing of the cellular phone. However, during disassembly, the battery cover is susceptible to being damaged, since a greater force is exerted thereon. As a result, it is inconvenient for a user to change a battery in the housing of the cellular phone.

Therefore, there is a room for improved in the arts.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary battery cover latch assembly. Moreover, in the drawings like reference numerals designate corresponding parts throughout the several views. Wherever possible, the same reference numbers are used throughout the drawings to refer to the same or like elements of an embodiment.

FIG. 1 is an assembled view of an exemplary embodiment of a battery cover latch assembly including a battery housing member and a battery cover.

FIG. 2 is an exploded view of the battery cover latch assembly shown in FIG. 1.

FIG. 3 is a partially enlarged view of the battery cover latch assembly shown in FIG. 2.

FIG. 4 is cross-sectional view of the battery cover latch assembly shown in FIG. 1.

FIG. 5 is a partially enlarged view of the battery cover latch assembly shown in FIG. 4.

### DETAILED DESCRIPTION OF THE EMBODIMENTS

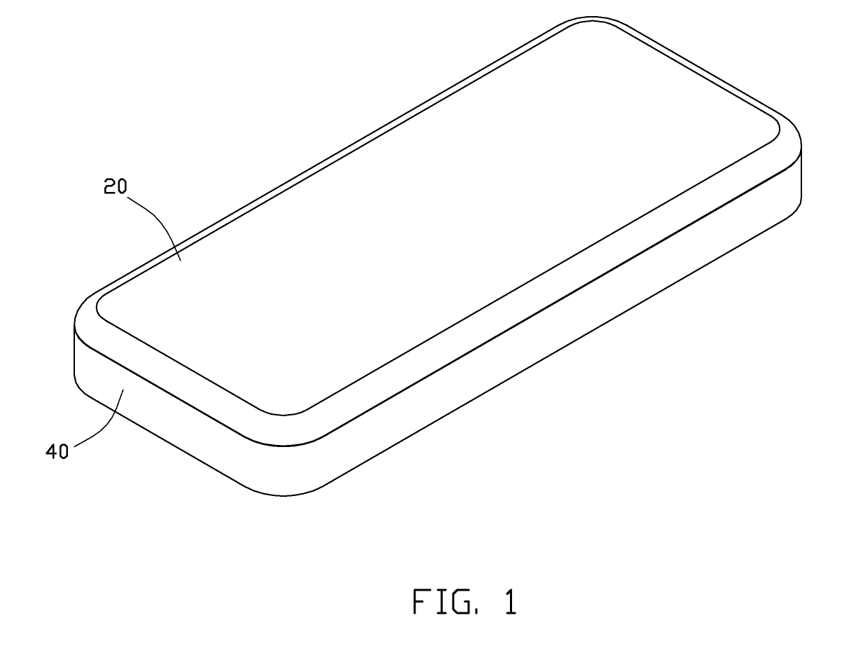

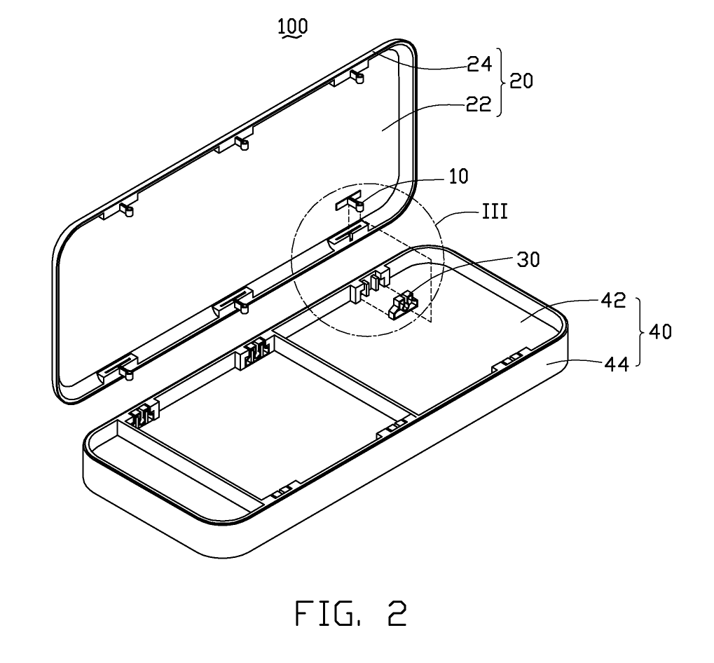

Referring to FIGS. 1 and 2, an exemplary battery cover latch assembly 100 used in a portable electronic device for accommodating a battery is shown. The battery cover latch assembly 100 includes a plurality of first latching elements 10, a portion of a battery cover 20, a plurality of second latching elements 30 and a portion of battery housing member 40. In this embodiment, there are six first latching elements 10, and the first latching elements 10 are symmetrically mounted to two opposite sides of the battery cover 20. The number of second latching elements 30 is equal to the number of first latching elements 10. The battery cover 20 is latched with the battery housing member 40 by the first latching elements 10 and the second latching elements 30.

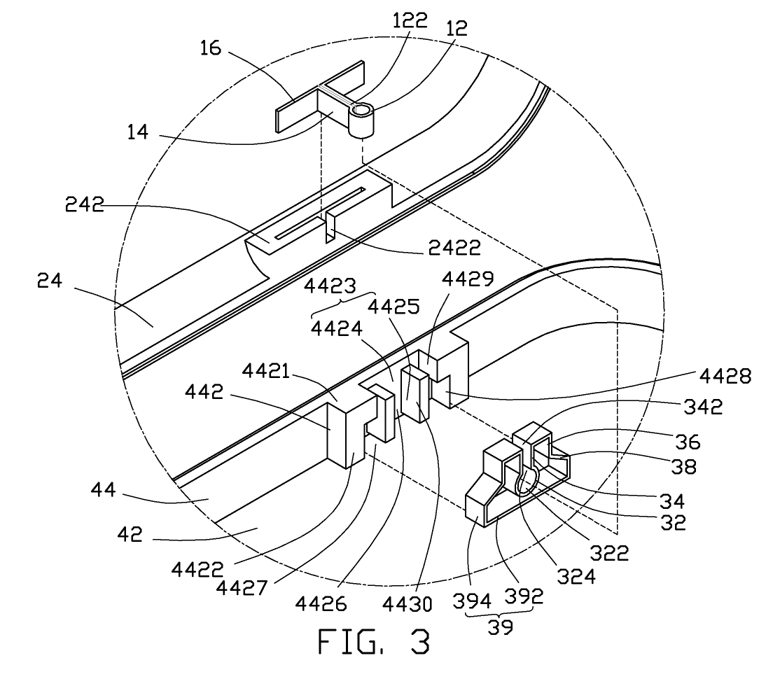

Referring to FIG. 3, each first latching element 10 is substantially T-shaped metallic resilient sheet, and may be made of magnesium alloy, aluminum alloy or stainless steel alloy. Each first latching element 10 includes a first latching portion 12, two first connecting portions 14, and two first retaining portions 16. The first latching portion 12 is a hollow cylinder and has a slit 122 radially defined therethrough. The first connecting portions 14 protrude from an outer surface of the first latching portion 12. The first retaining portions 16 respectively extend from a distal end of each first connecting portion 14 away from another first connecting portion 14. The first retaining portions 16 are retained to the battery cover 20 to retain the first latching elements 10 to the battery cover 20.

The battery cover 20 includes a first bottom wall 22 and two first sidewall 24 mounted to two opposite edges of the first bottom wall 22. Each first sidewall 24 has three first receiving portions 242 mounted thereon and spaced from each other. The first receiving portions 242 of one first sidewall 24 are symmetrical to the first receiving portions 242 of the other first sidewall 24. Each first receiving portion 242 has a T-shaped retaining slot 2422 defined therein. The retaining slots 2422 are configured to receive the first retaining portions 16 and partially receive the connecting portions 14, correspondingly.

The second latching elements 30 are metallic resilient sheets, and may be made of magnesium alloy, aluminum alloy or stainless steel alloy. Each second latching element 30 includes a second latching portion 32, two guiding portions 34, two bending portions 36, two second connecting portions 38 and a second retaining portion 39.

Each second latching portion 32 may be a hollow cylinder, and has a receiving space 322 defined in each second latching portion 32. The receiving space 322 is sized and configured to accommodate the first latching portion 12. Each second latching portion 32 has a notch 324 radially defined therethrough communicating with the receiving space 322.

The guiding portions 34 protrude from an outer surface of corresponding second latching portion 32 and respectively located at two sides of the notch 324, so a guiding groove 342 is defined between the guiding portions 34. The guiding grooves 342 communicate with the notch 324, so as to guide the first latching portions 12 into the receiving spaces 322. Moreover, the width of the guiding grooves 342 is slightly smaller than the diameter of the first latching portions 12, so the first latching portions 12 can be securely accommodated in the receiving spaces 322.

The bending portions 36 are substantially L-shaped and respectively protrude from a distal end of each guiding portion 34 away from another guiding portion 34. The connecting portions 38 protrude outwardly from a distal end of each bending portion 36, respectively. Each second retaining portion 39 includes a base plate 392 and two brackets 394 protruding from two opposite ends of the base plate 392. A distal end of each bracket 394 is connected to a second connecting portion 38, correspondingly.

The battery housing member 40 includes a second bottom wall 42 and two second sidewall 44 protruding from two opposite edges of the second bottom wall 42. Each second sidewall 44 has three second receiving portions 442 corresponding to the first receiving portions 242. The second receiving portions 442 are configured to mount the second latching elements 30 to the battery housing member 40.

Each second receiving portion 442 includes a first surface 4421 facing the battery cover 20 and a second surface 4422 parallel to the second sidewall 44. Each second receiving portion 442 has a T-shaped mounting space 4423 defined therein for receiving corresponding second latching element 30. The mounting space 4423 includes a first recess 4424 defined in the first surface 4421 through the second surface 4422, and a second recess 4425 defined in the second surface 4422 communicating with the first surface 4421. The first recess 4424 is smaller than the second recess 4425. Each second receiving portion 442 has a first inner wall 4426 parallel to the second surface 4422, a second inner wall 4427 parallel to the first surface 4421 and two opposite third inner walls 4428 formed in the second recess 4425 connecting with the second surface 4422. Each second receiving portion 442 further has two opposite fourth inner walls 4429 parallel to the third inner walls 4428 formed in the first recess 4424. Additionally, each first inner wall 4426 has two spaced blocks 4430 protruding thereon for securing corresponding second latching portions 32 therebetween. It is ensured that the distance between the blocks 4430 is slightly smaller than the diameters of the second latching portions 32, such that the second latching portions 32 can be firmly secured between the blocks 4430. The distance between the blocks 4430 and the second inner wall 4427 is slightly smaller the thickness of the base plate 392, to firmly secured the base plates 392 between corresponding blocks 4430 and corresponding second inner wall 4427.

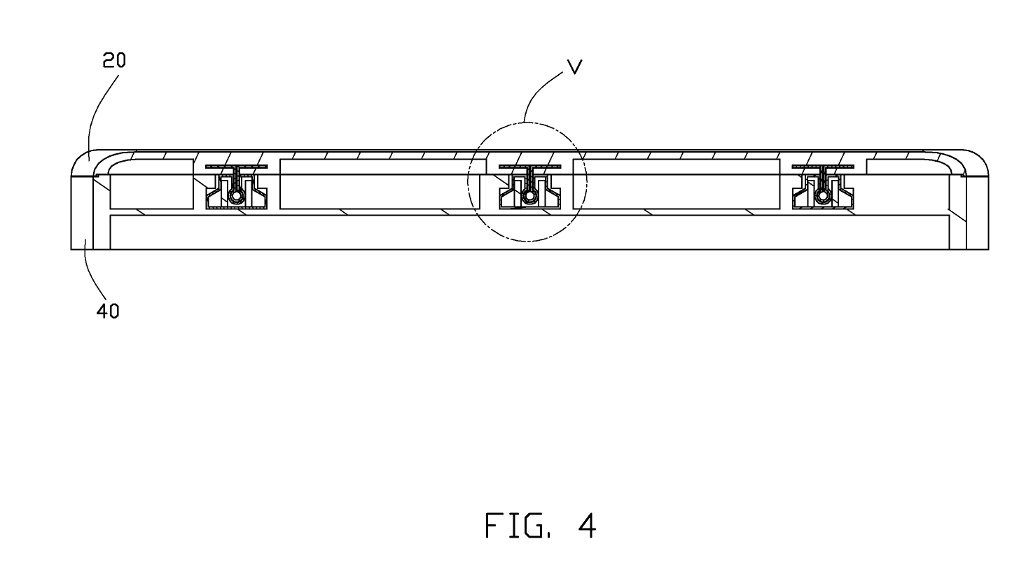

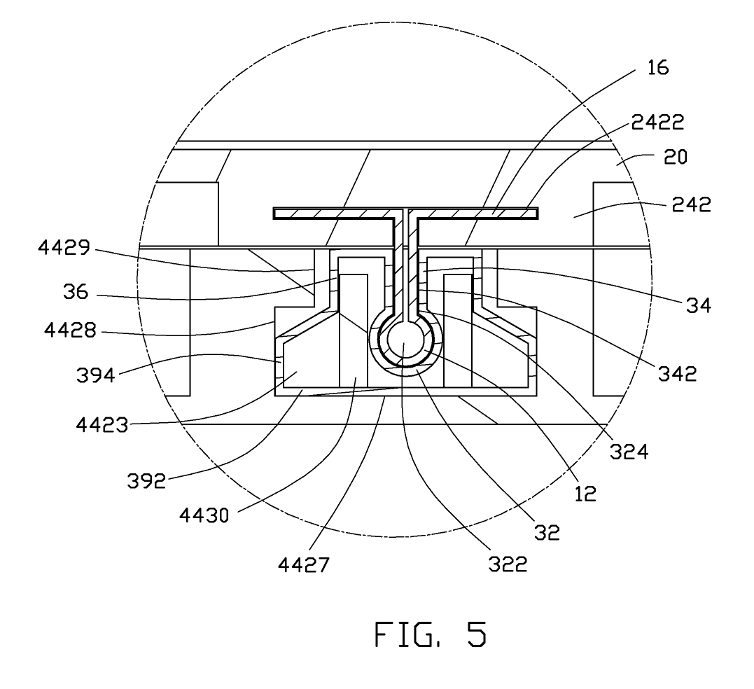

Referring to FIGS. 4 and 5, during assembling the battery cover latch assembly 100, firstly, the first retaining portions 16 of the first latching elements 10 are correspondingly fixed (e.g., hot melted) in the retaining slots 2422 of the battery cover 20 to retain the first latching elements 10 to the battery cover 20. Secondly, the second latching elements 30 are mounted to the mounting space 4423 of the battery housing member 40. At this time, the base plates 392 of the second latching elements 30 are correspondingly secured between the blocks 4430 and the second inner walls 4427. The second latching portions 32 are secured between corresponding blocks 4430. The brackets 394 correspondingly resist against the third inner walls 4428, the bending portions 36 are spaced from corresponding fourth inner walls 4429 to provide a space for the bending portions 36 to expand.

After that, the first latching elements 10 are aligned with the second latching elements 30, then the battery cover 20 is pressed towards the battery housing member 40. Thus, the first latching portions 12 are inserted into the guiding grooves 342. At this stage, the first latching portions 12 bias the guiding portions 34 toward the fourth inner walls 4429, so that the bending portions 36 are bent toward the fourth inner walls 4429 and accumulate elastic force. Additionally, the first latching portions 12 are compressed toward the slits 122 and accumulate elastic force, so the first latching portions 12 can more easily slide in the guiding grooves 342.

When the first latching portions 12 pass through the notches 324 into the receiving space 322, the guiding portions 34 and the bending portions 36 restore to their original state under previously accumulated elastic force of the bending portions 36. The first latching portions 12 restore to its original state under previously accumulating elastic force of itself. Thereby, the first latching portions 12 are firmly secured in the receiving spaces 322 of the second latching portions 32, to latch the battery cover 20 to the battery housing member 40.

When detaching the battery cover 20 from the battery housing member 40, the battery cover 20 is pulled away from the battery housing member 40, such that the first latching portions 12 slides out of the receiving spaces 322 of the second latching portions 32 until the first latching portions 12 entirely slide outwardly from the guiding grooves 342. At this time, the battery cover 20 is detached from the battery housing member 40

The first latching elements 10 and the second latching elements 30 are separately manufactured, then respectively mounted to the battery cover 20 and the battery housing member 40. Thus, when the battery cover 20 and the battery housing member 40 are manufactured by injection molding method, the battery cover latch assembly 100 can prevent from integrally molding the first latching elements 10 with the battery cover 20 and prevent from integrally molding the second latching elements 30 with the battery housing member 40, and the first latching elements 10 and the second latching elements 30 typically have complex structure, so as to facilitate molding the battery cover 20 and the battery housing member 40.

Moreover, the first latching elements 10 and the second latching elements 30 are optimally made of metal material, so can improve the abradability of the first latching elements 10 and the second latching elements 30. Thus, the work life of the battery cover latch assembly 100 can be prolonged.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latch assembly, comprising:
a battery housing member;
a battery cover;
a plurality of first latching elements, the first latching elements mounted to the battery cover, each first latching elements including a cylindrical first latching portion; and
a plurality of second latching elements, the second latching elements mounted to the battery housing member corresponding to the first latching elements, each second latching element having a hollow second latching portion defining a receiving space therein;
wherein the first latching portions are respectively secured in the receiving spaces of the second latching elements to secure the battery cover to the battery housing member.

2. The battery cover latch assembly as claimed in claim 1, wherein each first latching portion is a hollow cylinder radially defining a slit therethrough, each first latching element further includes two first connecting portions protruding an outer wall of each first latching portion besides two sides of the slit.

3. The battery cover latch assembly as claimed in claim 2, wherein each first connecting portion has a first retaining portion extending from a distal end thereof away from another connecting portion, the battery cover has a plurality of retaining slots corresponding to the first retaining portions, the first retaining portions are retained in the retaining slots.

4. The battery cover latch assembly as claimed in claim 3, wherein the first retaining portions are hot melted in the retaining slots.

5. The battery cover latch assembly as claimed in claim 2, wherein each second latching portion has a notch radially defined therethrough communicating with corresponding receiving space, the first latching portions are latched into the receiving spaces via the notches.

6. The battery cover latch assembly as claimed in claim 5, wherein each second latching element further has two guiding portion located besides two sides of corresponding notch, each second latching element has a guiding groove formed between corresponding guiding portions communicating with the receiving space, the guiding grooves are configured to guide the first latching portions into the receiving spaces.

7. The battery cover latch assembly as claimed in claim 6, wherein each second latching element has two bending portions extending from a distal end of each guiding portion, when the first latching portions are inserted into the guiding grooves, the bending portions are biased to accumulate elastic force for restoring the guiding portions to their original state.

8. The battery cover latch assembly as claimed in claim 7, wherein each second latching element further includes a second retaining portion including a base plate and two brackets extending from two opposite ends of the base plate, a distal end of each bracket is connected to a second connecting portion, correspondingly.

9. The battery cover latch assembly as claimed in claim 8, wherein the battery housing member has a plurality of mounting space defined therein corresponding to the second latching elements, the second latching elements are secured in the mounting spaces.

10. The battery cover latch assembly as claimed in claim 9, wherein the first latching elements and the second latching elements are both made of metallic material.

11. A portable electronic device, comprising:
a battery housing member;
a battery cover;
a plurality of first latching elements, the first latching elements mounted to the battery cover, each first latching elements including a first latching portion; and
a plurality of second latching elements, the second latching elements mating with the first latching elements, and each second latching element having a second latching portion for correspondingly engaging with the first latching portions;
wherein the first latching portions and the second latching portions are separately manufactured, the first latching portions are mounted to the battery cover, the second latching portions are mounted to the battery housing member.

12. The portable electronic device as claimed in claim 11, wherein each first latching portion is hollow and radially defines a slit therethrough, each first latching element further includes two first connecting portions protruding an outer wall of each first latching portion besides two sides of corresponding slit.

13. The portable electronic device as claimed in claim 12, wherein each first connecting portion has a first retaining portion extending from a distal end thereof away from another connecting portion, received in a plurality of retaining slots defined in the first retaining portions.

14. The portable electronic device as claimed in claim 13, wherein the first retaining portions are hot melted in the retaining slots.

15. The portable electronic device as claimed in claim 11, wherein each second latching portion is a hollow cylinder defining a receiving space therein, each second latching portion further has a notch radially defined therethrough communicating with corresponding receiving space, the first latching portions are latched into the receiving spaces by the notches.

16. The portable electronic device as claimed in claim 15, wherein each second latching element further has two guiding portion located besides two sides of corresponding notch, each second latching element has a guiding groove formed between corresponding guiding portions communicating with the receiving space, the guiding grooves are configured to guide the first latching portions to the receiving spaces.

17. The portable electronic device as claimed in claim 16, wherein each second latching element has two bending portions extending from a distal end of each guiding portion, when the first latching portions are inserted into the guiding grooves, the bending portions are biased to accumulate elastic force for restoring the guiding portions to their original state.

18. The portable electronic device as claimed in claim 17, wherein each second latching element further includes a second retaining portion including a base plate and two brackets extending from two opposite ends of the base plate, a distal end of each bracket is connected to a second connecting portion, correspondingly.

19. The portable electronic device as claimed in claim 18, wherein the battery housing member has a plurality of mounting space defined therein corresponding to the second latching elements, the second latching elements are secured in the mounting spaces.

20. The battery cover latch assembly as claimed in claim 19, wherein the first latching elements and the second latching elements are both made of metallic material.
